(19) United States
(12) Patent Application Publication
(10) Pub. No.: US 2019/0008291 A1
(43) Pub. Date: Jan. 10, 2019

(54) BAGGING STATION SYSTEM AND BAGGING STATION BRACKET

(71) Applicant: Walmart Apollo, LLC, Bentonville, AR (US)

(72) Inventor: Yurgis Mauro Bacallao, Centerton, AR (US)

(21) Appl. No.: 16/026,457

(22) Filed: Jul. 3, 2018

Related U.S. Application Data
(60) Provisional application No. 62/529,174, filed on Jul. 6, 2017.

(51) Int. Cl. A47F 9/04; B65B 67/12; F16M 13/02

(52) U.S. Cl. CPC A47F 9/042; B65B 67/1266; B65B 2067/1294; B65B 67/1233; F16M 13/02; B65B 67/1227

(57) ABSTRACT

Described is a bagging station system for dispensing shopping bags. The bagging station system includes a bracket and a bagging station. The bracket is coupled to a wall. The bagging station is hung from the bracket. The bracket includes a support plate and at least one hook rail coupled to the support plate. The support plate has a first and a second slot opening in the support plate. The hook rail has at least one pin that extends through one of the first or the second slot opening to couple the hook rail to the support plate. With the support plate coupled to a wall, one or more hook rail coupled to the support plate, and the bagging station coupled to the one or more hook rail, the bagging station is available to dispense shopping bags to employees or customers of a retail store.

### CROSS REFERENCE TO RELATED APPLICATION

This invention claims priority to U.S. provisional patent application Ser. No. 62/529,174, filed Jul. 6, 2018, and entitled “Bagging Station System and Bagging Station Bracket”, which is incorporated entirely herein by reference.

### BACKGROUND OF THE INVENTION

### Technical Field

This invention relates to bagging stations in retail stores, and specifically to a bracket for mounting a bagging station to a wall.

### State of the Art

A bagging station is a device that holds a stack of shopping bags, usually plastic shopping bags, and dispenses the shopping bags so that the shopping bags can be filled with products a customer purchases in a retail store. Bagging stations are often placed at checkout counters in the retail store so that baggers can place products that have gone through checkout in a bag from the bagging station. There are mounting structures for the bagging stations at the checkout counters because customers purchase products at checkout counters, and the products are bagged at the checkout counters. There are times, however, when bagging stations are used at locations other than a checkout station in a retail store, and there may not be a mounting structure for the bagging station in these other locations. A bagging station may be used at a service counter where they process returns, for instance, or other locations that do not have bagging station mounting structures. When a bagging station is used at a location that does not have a bagging station mounting structure, the bagging station is often placed on the ground. This requires the employees to bend or crouch to fill and lift bags from the ground, which can cause employee injury and strain.

Accordingly, what is needed is a bracket that mounts to a wall and holds a shopping bag bagging station, and a bracket that can be easily mounted to a wall in various places throughout a retail store, not just at checkout registers.

### BRIEF DESCRIPTION OF THE DRAWINGS

FIG. 1 shows a perspective view of a bagging station system including a shopping bag bagging station and a bracket for holding the bagging station;

FIG. 2 shows an exploded side view of the bagging station system of FIG. 1;

FIG. 3 shows a rear view of the bagging station system of FIG. 1;

FIG. 4 shows a front perspective view of a bracket for holding a shopping bag bagging station;

FIG. 5 shows a side view of the bracket of FIG. 4;

FIG. 6 shows an exploded side view of the bracket of FIG. 4;

FIG. 7 shows a front perspective view of the components of the bracket of FIG. 4, including a support plate and two hook rails;

FIG. 8 shows a front view of a support plate;

FIG. 9 shows a front perspective view of a hook rail;

FIG. 10 shows a front view of the hook rail of FIG. 9;

FIG. 11 shows a top view of the hook rail of FIG. 9;

FIG. 12 shows a rear view of the hook rail of FIG. 9; and

FIG. 13 illustrates a method of mounting a bagging station to a wall.

### DETAILED DESCRIPTION OF EMBODIMENTS OF THE INVENTION

As discussed above, embodiments of the present invention relate to bagging stations in retail stores and, specifically, to a bracket for mounting a bagging station to a wall. A shopping bag bagging station, also referred to as a bagging station, is a device that holds a stack of shopping bags, usually plastic shopping bags, and dispenses the shopping bags so that the shopping bags can be filled with products a customer purchases in a retail store. There are usually mounting structures for a bagging stations at each checkout counter in retail stores because customers purchase their products at the checkout counters, and the products are bagged at that same location. There are times, however, when bagging stations are used at locations other than checkout stations. Often, there is not a mounting structure for the bagging station at these other locations. Bagging stations can be useful at a service counter where they process returns, for instance. Bagging stations can be useful in a back room where shopping bags are used, or other locations that do not have bagging station mounting structures. When a bagging station is used at a location that does not have a bagging station mounting structure, the bagging station is often placed on the ground. This requires the employees to bend or crouch to fill the bags and to lift the bags off of the ground, which can cause employee injury and strain.

Disclosed is a bagging station system that is mounted to a wall. The bagging station system includes a shopping bag bagging station, and a bracket that mounts to a wall. The bagging station is hung from the bracket so the bagging station hangs from the wall. The bracket can be hung from a wall in any location in a retail store, so that the bagging station is available for use in locations other than checkout stations. The provides employees with easy access to bagging stations and does not require reaching to the ground to fill bags and retrieve the full bags. The bracket includes a support plate that couples to the wall, and a first and a second hook rail that removably couples to the support plate. The support plate has a first and a second slot opening. The first hook rail has pins that extend through the first slot opening to couple the first hook rail to the support plate. The second hook rail has pins that extend through the second slot opening to couple the second hook rail to the support plate. The bagging station hangs from the hook rail. The bagging station has a first frame bar that hangs from the first hook rail, and a second frame bar that hangs from the second hook rail. The bagging station is thus mounted to the wall, and can be used to dispense shopping bags. The bagging station can be easily removed from the bracket when it is not needed. The bracket can stay coupled to the wall for when a bagging station is desired.

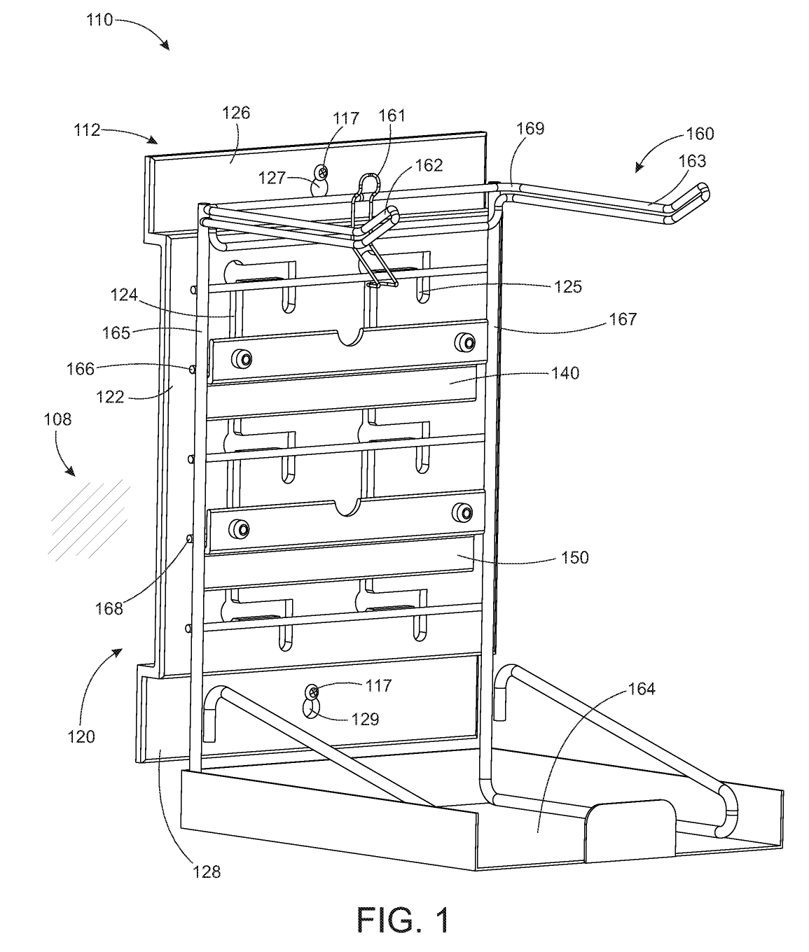

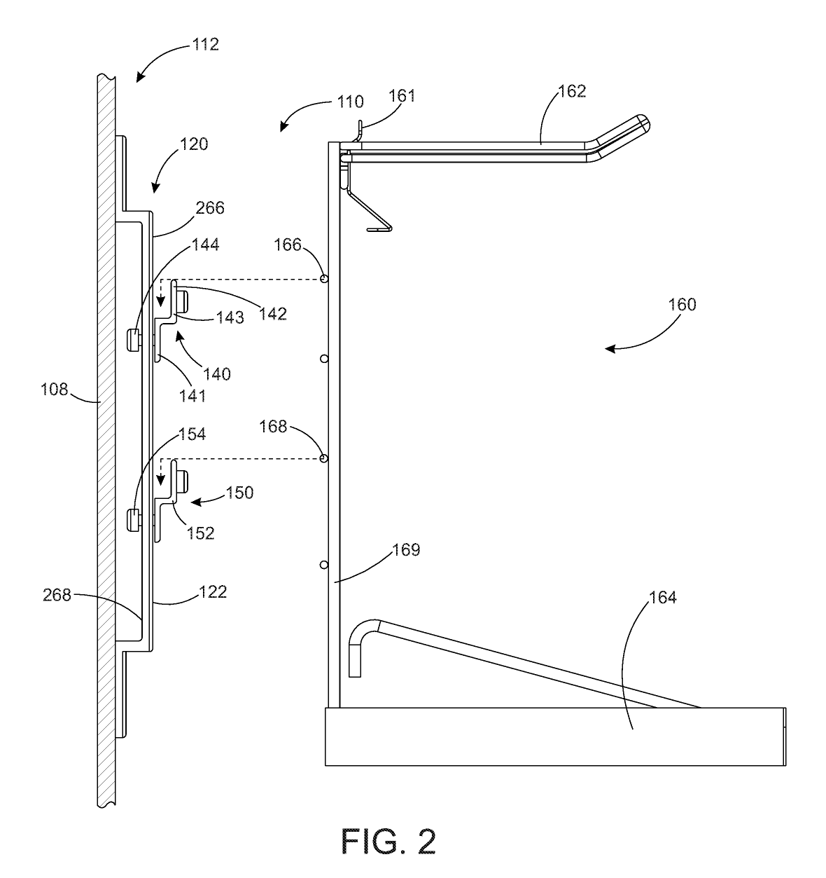

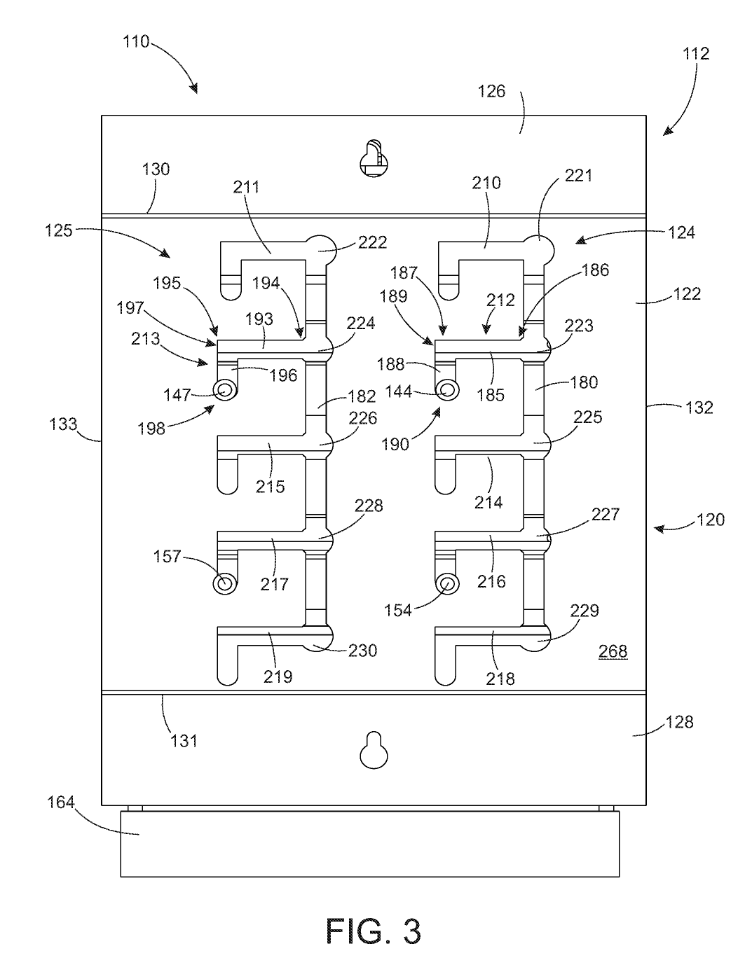

FIG. 1, FIG. 2, and FIG. 3 show a bagging station system 110. FIG. 1 shows a front perspective view of bagging station system 110. FIG. 2 shows an exploded side view of bagging station system 110. FIG. 3 shows a rear view of bagging system 110. Bagging system 110 includes a bracket 112 for holding a shopping bag bagging station, and a shopping bag bagging station 160 (also referred to as bagging station 160) coupled to bracket 112. Bracket 112 is coupled to a wall 108 in FIG. 1 and FIG. 2. Bracket 112 is coupled to wall 108 so that bagging station 160 can be hung and used from wall 108. Bracket 112 includes a support plate 120 and at least one hook rail. In this embodiment, bracket 112 includes two hook rails, first hook rail 140 and second hook rail 150. Hook rails 140 and 150 are removably coupled to support plate 120. Bagging station 160 is hung from hook rails 140 and 150, as shown in FIG. 1 and FIG. 2. Bagging station 160 includes a first horizontal coupling bar 166 that removably hangs from first hook rail 140, and a second horizontal coupling bar 168 that removably hangs from second hook rail 150. With bagging station 160 hung from hook rails 140 and 150, and support plate 120 coupled to wall 108, bagging station 160 is available to dispense bags for employees or customers in the retail store. Bagging station system 110 can be hung from wall 108 in a convenient location and height so that bagging station 160 is easy to access, use, and remove from bracket 112 when not needed.

Shopping bag bagging station 160 dispenses shopping bags, usually plastic shopping bags. Bagging station 160 includes a frame structure 169 formed of rigid rails, as shown in FIG. 1 and FIG. 2. Bagging station 160 is usually mounted at a checkout station, but, in this embodiment, is hung from bracket 112 that is mounted to wall 108. A bag holder hook 161 is coupled to frame structure 169 at the top end of bagging station 160. Bagging station 160 is used by hanging a stack of plastic shopping bags from bag holder hook 161. Bagging station 160 also includes a pair of handle holder arms 162 and 163 that extend from the top end of bagging station 106 on either side of bag holder hook 161. Each handle holder arm 162 and 163 holds the handles of the stack of shopping bags hung from bag holder hook 161. Frame 169 includes first and second vertical frame bars 165 and 167, and a plurality of horizontal bars connecting first and second vertical frame bars 165 and 167, as shown in FIG. 1. The plurality of horizontal bars connecting first and second vertical frame bars 165 and 167 includes a first horizontal coupling bar 166 and a second horizontal coupling bar 168, as shown in FIG. 1 and FIG. 2. First and second horizontal coupling bars 166 and 168 each are coupled to and extend between first and second vertical frame bars 165 and 167. First and second horizontal coupling bars 166 and 168 couple first vertical frame bar 165 and second vertical frame bar 167 to each other and add strength to frame structure 169. A support plate 164 is at a bottom end of bagging station 160 to support the shopping bag and the items in the shopping bag as the shopping bag is being filled. Once a shopping bag is filled, it is removed from bagging station 160 and the next shopping bag is opened and filled.

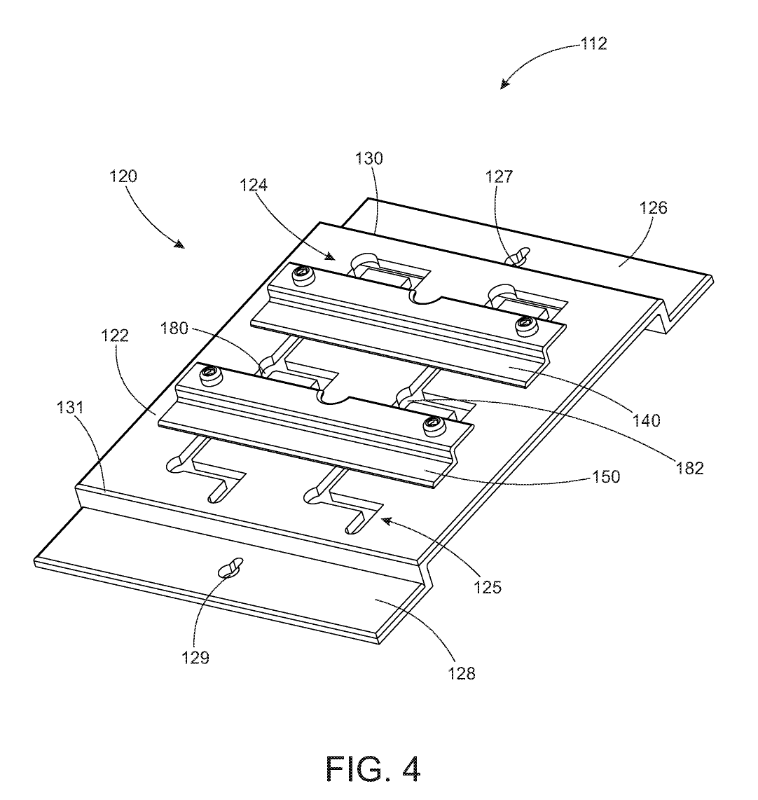

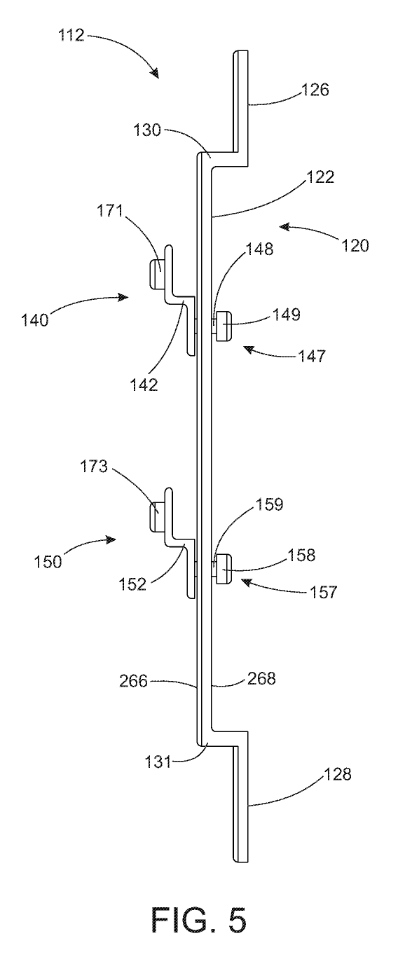

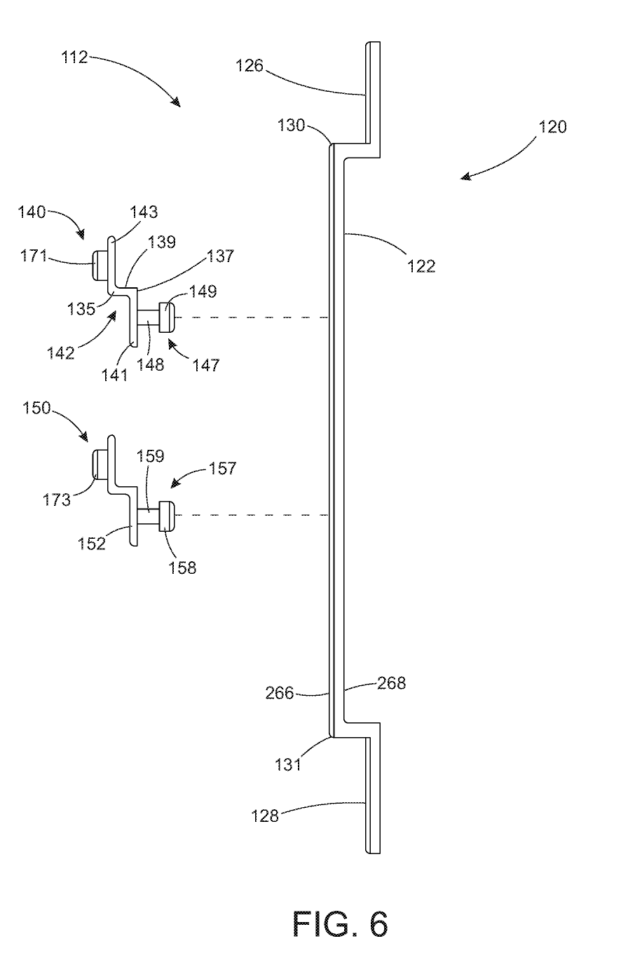

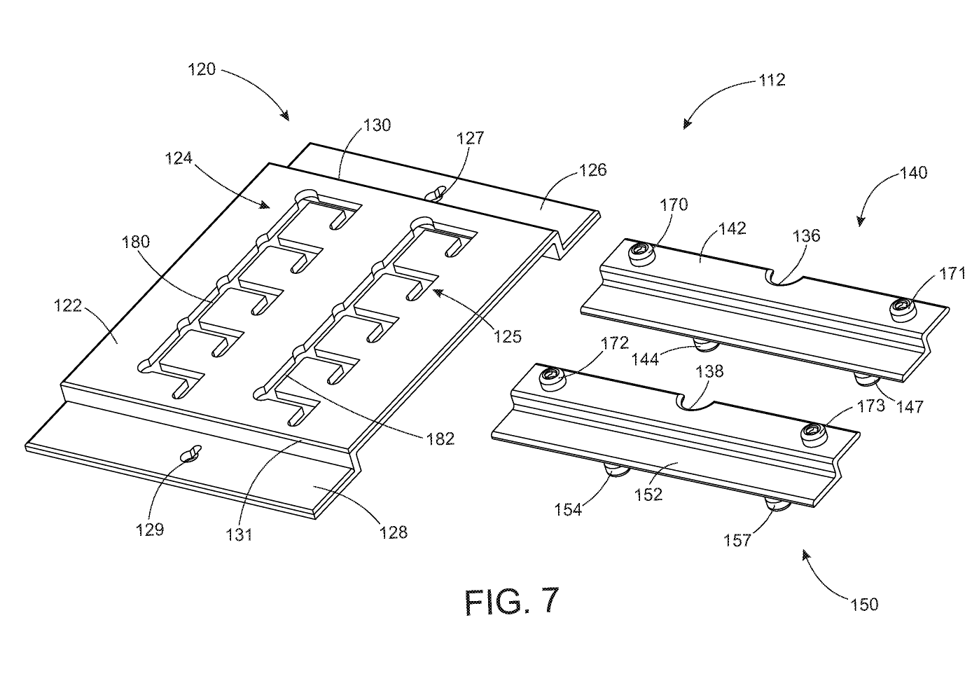

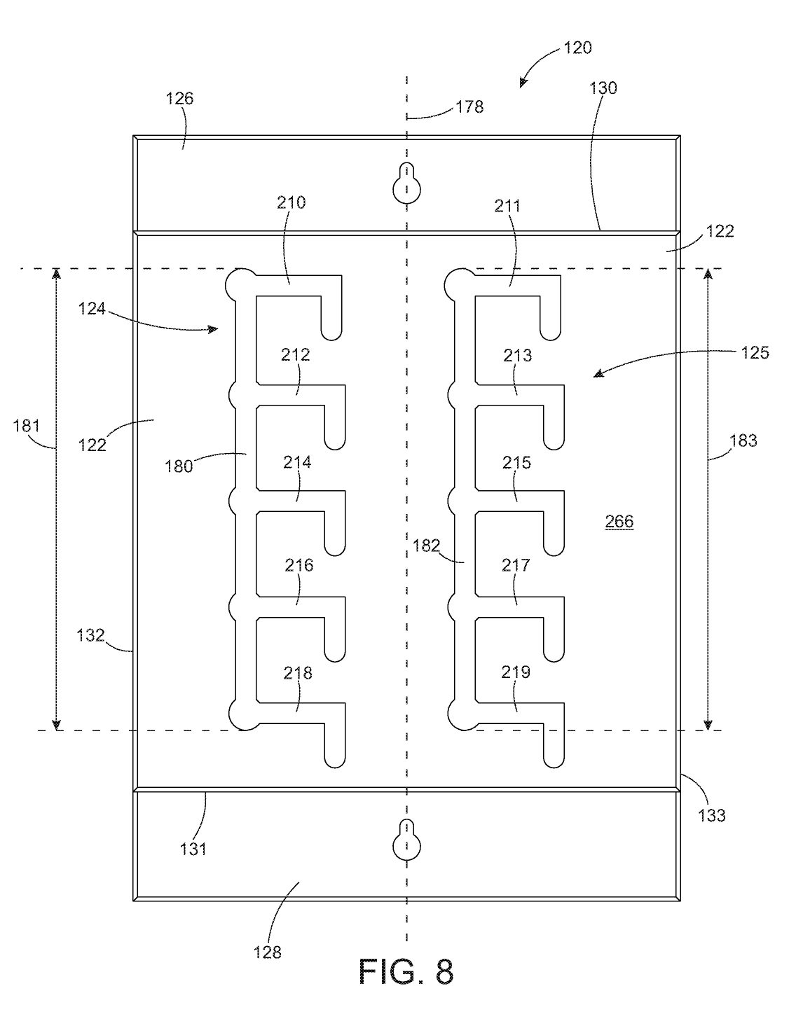

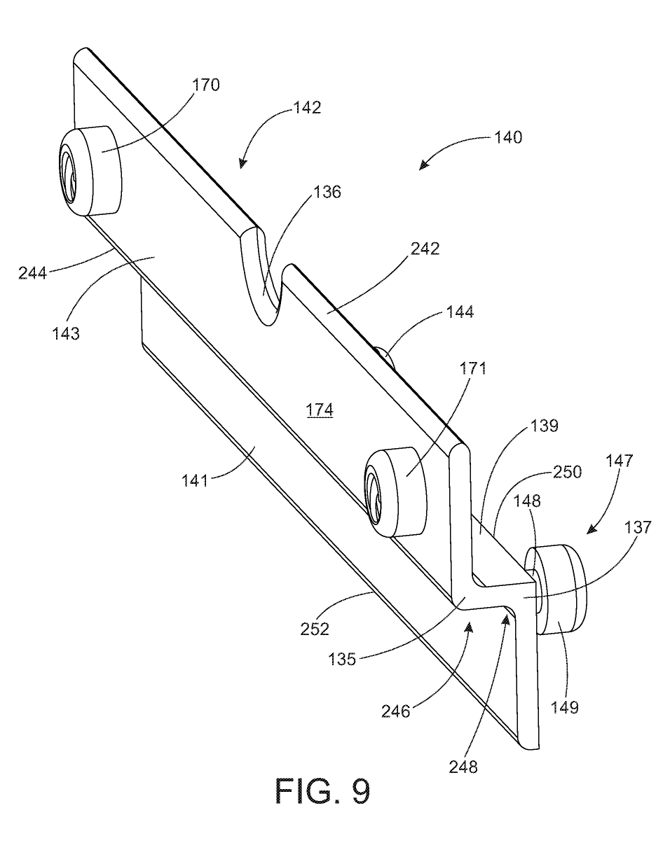

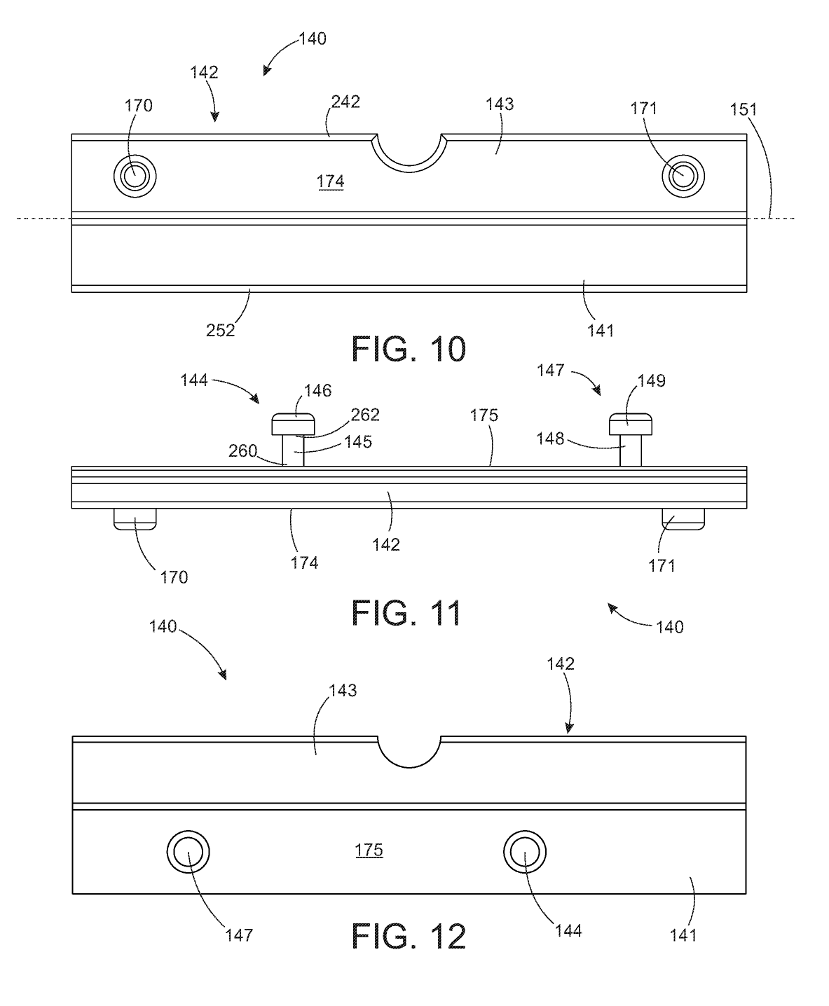

FIG. 4 through FIG. 12 show details of bracket 112 for holding shopping bag bagging station 160. FIG. 4 shows a front perspective view of bracket 112. FIG. 5 shows a side view of bracket 112. FIG. 6 shows a side exploded view of bracket 112. FIG. 7 shows a front perspective view of the components of bracket 112, which includes support plate 120 and hook rails 140 and 150. FIG. 8 shows a front view of support plate 120. FIG. 9 shows a front perspective view of hook rail 140. FIG. 10 through FIG. 12 shows front, top, and rear views of hook rail 140, respectively.

Bracket 112 includes support plate 120 and at least one hook rail. In this embodiment, bracket 112 includes two hook rails, first hook rail 140 and second hook rail 150, but this is not meant to be limiting. In some embodiments, bracket 112 includes one hook rail 140. In some embodiments, bracket 112 includes more than two hook rails. Each hook rail 140 and 150 have pins extending from them that extend through one of first or second slot openings 124 or 125 in support plate 120 to couple hook rail 140 or 150 to support plate 120, as best seen in FIG. 3 and FIG. 6. Hook rail 140 has a first pin 144 and a second pin 147 extending from a rear surface 175 of hook rail 140, see FIG. 3 and FIG. 6, and FIG. 9 through FIG. 12. Similarly, hook rail 150 has a third pin 154 and a fourth pin 157 extending from the rear surface of hook rail 150, see FIG. 2, FIG. 3, and FIG. 5. Pins 144, 147, 154, and 157 removably couple hook rails 140 and 150 to support plate 120. First pin 144 and third pin 154 extend through first slot opening 124 to couple hook rails 140 and 150 to support plate 120, see FIG. 3. Second pin 147 and fourth pin 154 extend through second slot opening 125 to couple hook rails 140 and 150 to support plate 120. Bagging station 160—specifically first horizontal coupling bar 166 and second horizontal coupling bar 168—hangs on hook rails 140 and 150 to couple bagging station 160 to support plate 120, as shown in FIG. 1 and FIG. 2.

Support plate 120 includes a plate 122, which is a rectangular plate of rigid material, first slot opening 124 and second slot opening 125 extending through rigid plate 122 (best seen in FIG. 3, FIG. 7, and FIG. 8), and a first and a second coupling flange 126 and 128 extending from plate 122. Rectangular rigid plate 122 has a plate top edge 130, a plate bottom edge 131, a plate first side edge 132, a plate second side edge 133, and a plate longitudinal axis 178 (FIG. 8). Coupling flanges 126 and 128 are used to couple support plate 120 to wall 108. Coupling flange 126 extends from, and is coupled to, plate top edge 130. Coupling flange 128 extends from, and is coupled to, plate bottom edge 131 of plate 122. Coupling flange 126 has a coupler hole 127, and coupling flange 128 has a coupler hole 129 (FIG. 1, FIG. 4, and FIG. 7). Couplers such as bolts or screws are extended through coupler holes 127 and 129 to couple support plate 120 to wall 108. In the embodiment shown in FIG. 1, screws 117 are extended through holes 127 and 129 to couple support plate 120 to wall 108.

First and second slot openings 124 and 125 are used to couple hook rail 140 and 150 to support plate 120. First and second slot openings 124 and 125 are slot openings cut through support plate 120. First and second slot openings 124 and 125 extend through rectangular rigid plate 122 of support plate 120 from a plate front surface 266 to a plate rear surface 268 (see FIG. 5, for example). First and second slot openings 124 and 125 are called “slot” openings because they are openings, or holes, through rigid plate 122 that are generally slot-shaped, meaning their length is much longer than their width. First and second slot openings 124 and 125 are used to couple pins 144, 147, 154, and 157 to support plate 120, and to allow pins 144, 147, 154, and 157 to slide along the slot openings. First and second slot openings 124 and 125 do not open to an edge of rigid plate 122, meaning neither first or second slot opening 124 and 125 open to, or reach, any of plate top edge 130, plate bottom edge 131, plate first side edge 132, or plate second side edge 133, as can be seen in the figures.

First slot openings 124 includes a first longitudinal slot 180, and second slot opening 125 includes a second longitudinal slot 182, best seen in FIG. 3, FIG. 7, and FIG. 8. First and second longitudinal slot 180 and 182 are straight slot openings that extend longitudinally in plate 122, which means both first and second longitudinal slot 180 and 182 are parallel to plate longitudinal axis 178 (FIG. 8). First longitudinal slot 180 has a first longitudinal slot length 181 (FIG. 8). Second longitudinal slot 182 has a second longitudinal slot length 183. In this embodiment, first longitudinal slot length 181 has the same value as second longitudinal slot length 183, but this is not meant to be limiting. In this embodiment, first and second longitudinal slots 180 and 182 have the same length. In some embodiments, first and second longitudinal slots 180 and 182 have different lengths. First and second longitudinal slots 180 and 182 each have a number of junctions. In this embodiment, first longitudinal slot 180 has junctions 221, 223, 225, 227, and 229, as shown in FIG. 3. Second longitudinal slot 182 has junctions 222, 224, 226, 228, and 230. Junctions 221 through 230 are wide areas in longitudinal slots 180 and 182 that are used to insert pins 144, 147, 154, and 157 of first and second hook rails 140 and 150 in order to couple hook rails 140 and 150 to rigid plate 122.

First and second slot opening 125 and 125 each includes at least one L slot. An L slot is an L-shaped slot opening through rigid plate 122 that extends from, and connect with, either first or second longitudinal slot 180 or 182. Extending from or off of, and connecting with, means the slot openings are continuous between the longitudinal slots and the L slots. This is so that a pin can slide along a longitudinal slot and move into an L slot without having to remove the pin from the longitudinal slot. In this embodiment, first slot opening 124 includes five L slots extending off of first longitudinal slot 180, as best seen in FIG. 3 and FIG. 8. Second slot opening 125 includes five L slots extending off of second longitudinal slot 182.

L slots 210, 212, 214, 216, and 218 each extend off of first longitudinal slot 180, as shown in FIG. 3 and FIG. 8. L slots 211, 213, 215, 217, and 219 each extend off of second longitudinal slot 182, as shown in FIG. 3 and FIG. 8. Each hook rail 140 and 150 has a set of two pins extending out from the rear of the hook rail, as can be seen for first hook rail 140 in FIG. 9 and FIG. 12. Pins 144 and 147 extend from the rear of first hook rail 140. Each of pin 144 and 147 extend through one of L slot 210, 211, 212, 213, 214, 215, 216, 217, 218 or 219 to couple first hook rail 140 to support plate 120. Similarly, pins 154 and 157 extend from a rear of second hook rail 150, and extend through one of L slot 210, 211, 212, 213, 214, 215, 216, 217, 218 or 219 to couple second hook rail 150 to support plate 120.

Each L slot 210, 211, 212, 213, 214, 215, 216, 217, 218, and 219 is an L-shaped slot opening through rigid plate 122 of support plate 120. Each L slot 210, 211, 212, 213, 214, 215, 216, 217, 218, and 219 has a straight slot shaft and a straight slot leg. For example, and referring to FIG. 3, first slot opening 124 includes first longitudinal slot 180 and first L slot 212 (as well as L slots 210, 214, 216, and 218). “First” is used here to indicate a first slot for discussion, and can apply to any of the L slots. First L slot 212 has a first L slot shaft 185 and a first L slot leg 188. First L slot shaft 185 has a first L slot shaft first end 186 that joins (connects with) first longitudinal slot 180 at junction 223. First L slot shaft 185 has a first L slot shaft second end 187 that opposes first L slot shaft first end 186. First L slot shaft 185 extends perpendicularly from longitudinal slot 180 in this embodiment, but this is not meant to be limiting. First L slot leg 188 has a first L slot leg first end 189 that joins (connects with) first L slot shaft 185 at first L slot shaft second end 187. First L slot leg 188 has a first L slot leg second end 190 that opposes first L slot leg first end 189. First L slot leg 188 is perpendicular to first L slot shaft 185, in this embodiment, and parallel to first longitudinal slot 180, but this is not meant to be limiting. First L slot leg second end 190 is where pin 144 is captured and rests to couple hook rail 140 to rectangular rigid plate 122 of support plate 120, as shown in FIG. 3. In order to couple hook rail 140 to rectangular rigid plate 122 of support plate 120, first pin 144 is extended through first longitudinal slot 180, at junction 223, for example but not by way of limitation. First pin 144 can be slid up and down first longitudinal slot 180 to reach an L slot that is at a desired height. First pin 144, in this embodiment, is slid from first longitudinal slot 180 to first L slot 212 at junction 223. First pin 144 is slid along first L slot shaft 185 and first L slot leg 188 and comes to rest at first L slot leg second end 190.

First pin 144 has a first pin head 146 (see FIG. 11) that fits through first longitudinal slot 180 at junctions 221, 223, 225, 227, and 229. Longitudinal slot 180 in this embodiment is too narrow to allow first pin head 146 to slide through first longitudinal slot 180, except at junctions 221, 223, 225, 227, and 229, which are wider areas for first pin head 146 to pass through, as shown in FIG. 3. Once pin 144 is slid to first L slot 212, pin 144 cannot be removed from first L slot 212 because the width of first L slot shaft 185 and first L slot leg 188 are not wide enough to allow first pin head 146 to be removed. With first pin 144 located at first L slot leg second end 190, first pin 144 couples hook rail 140 to support plate 120, and first pin 140 is captured at first leg second end 190 until it is desired to remove hook rail 140 from support plate 190. “Captured” in this discussion means that first pin head 146 is too large to slide through first L slot leg 188, and gravity keeps first hook rail 140 from moving, so first pin 144 is at rest and holds first hook rail 140 in place.

Similarly, second slot opening 125 includes second longitudinal slot 182, and L slots 211, 213, 215, 217, and 219. Second L slot 213 has a second L slot shaft 193 with a second L slot shaft first end 194 and a second L slot shaft second end 195 opposing second L slot shaft first end 194. Second L slot shaft first end 194 joins (connects with) second longitudinal slot 182 at junction 224, as shown in FIG. 3. Second L slot shaft 193 is perpendicular to second longitudinal slot 182. Second L slot 213 has a second L slot leg 196 with a second L slot leg first end 197 and a second L slot leg second end 198 opposing second L slot leg first end 197. Second L slot leg first end 197 joins second L slot shaft 193 at second L slot shaft second end 195. Second L slot leg 196 is perpendicular to second L slot shaft 193 and parallel to second longitudinal slot 182 in this embodiment. Second L slot shaft 193 is colinear with first L slot shaft 185. To couple hook rail 140 to rigid plate 122 of support plate 120, second pin 147 is extended through second longitudinal slot 182, at junction 224, for example. Second pin 147 then slides along second L slot shaft 193 and second L slot leg 196 to second L slot leg second end 198, where second pin 147 is captured and rests until it is desired to remove hook rail 140 from support plate 190. Second pin 147 has a second pin head 149 (FIG. 10) that fits through junctions 222, 224, 226, 228, and 230, but not through second L slot shaft 193 or second L slot leg 196.

First pin 144 extends through first slot opening 124 and second pin 147 extends through second slot opening 125 to couple hook rail 140 to support plate 120. Specifically, first pin 144 extends through first L slot 212 and second pin 147 extends through second L slot 213 to couple hook rail 140 to support plate 120 in this embodiment.

With first pin 144 resting and captured at first L slot leg second end 190, and second pin 147 captured and resting at second L slot leg second end 198, first hook rail 140 is securely coupled to rigid plate 122 of support plate 120, and first hook rail 140 is able to hold bagging station 160 by hanging bagging station horizontal coupling bar 166 from hook rail 140, as shown in FIG. 1 and FIG. 2. First hook rail 140 is removed from support plate 120 by sliding pins 144 and 147 along first and second L slots 212 and 213, respectively, to first and second longitudinal slots 180 or 182. First and second pins 144 and 147 are removed from first and second longitudinal slots 180 and 182 by sliding first and second pins 144 and 147 to junctions 223 and 224, or any of the other junction pairs. First and second pin heads 146 and 149 can be removed from first and second longitudinal slots 180 and 182 through junctions 223 and 224, or any of the other junctions 221, 222, 225, 226, 227, 228, 229, or 230.

In the embodiment shown in the figures, second hook rail 150 is similarly coupled to rectangular rigid plate 122 of support plate 120 using, for example, a third L slot 216 and a fourth L slot 217, as best seen in FIG. 1 through FIG. 6. Third pin 154 extends through first slot opening 124 and fourth pin 157 extends through second slot opening 125 to couple hook rail 150 to support plate 120, see FIG. 3.

Second horizontal coupling bar 168 is hung from second hook rail 150 to couple bagging station 160 to bracket 112, as shown in FIG. 1 and FIG. 2.

First and second hook rails 140 and 150 can be coupled to any of L slots 210, 211, 212, 213, 214, 215, 216, 217, 218, or 219 depending on the desired height and spacing of hook rails 140 and 150 to hold bagging station 160. In some embodiments, a different form of bagging station is hung from bracket 112, which may require a different spacing or height of hook rails 140 and 150.

FIG. 9 through FIG. 12 show details of first hook rail 140. Second hook rail 150 is a duplicate of first hook rail 140. In some embodiments, only hook rail 140 is used to couple bagging station 160 to support plate 120. In some embodiments, more than two hook rails 140 and 150 are used to couple bagging station 160 to support plate 120. The number of hook rails used for bagging station system 110 and bracket 112 is chosen based on the configuration of bagging station 160 and the weight of bagging station 160, for example. In some embodiments, a bagging station with a different form factor is hung from bracket 112.

FIG. 9 shows a front perspective view of hook rail 140. FIG. 10 shows a front view of hook rail 140. FIG. 11 shows a top view of hook rail 140. FIG. 12 shows a rear view of hook rail 140.

Hook rail 140 is formed of an elongate Z bar 142. A Z bar is a bar of rigid material with two longitudinal bends 135 and 137 that give the Z bar a cross-section that resembles a “Z” or an “S” (and a Z bar is sometimes referred to as an “S” bar), as can be seen in FIG. 5, FIG. 6, and FIG. 9. Bends 135 and 137 are longitudinal because they are parallel to a longitudinal axis 151 (FIG. 10) of elongate Z bar 142. The two longitudinal bends 135 and 137 divide elongate Z bar 142 into a Z bar lower section 141, a Z bar extension section 139, and a Z bar upper section 143, as shown in FIG. 6 and FIG. 9 through FIG. 12. Extension section 139 is perpendicular to lower section 141 and upper section 143 and extends between lower section 141 and upper section 143 between first bend 135 and second bend 137, best seen in FIG. 6 and FIG. 9. Lower section 141 and upper section 143 are parallel to each other in this embodiment.

Z bar upper section 143 is comprised of a bar of rigid material having an upper section first edge 242 and an upper section second edge 244 opposing upper section first edge 242, see FIG. 9.

Z bar extension section 139 is formed of a bar of rigid material having an extension section first edge 246 coupled to Z bar second edge 244 (FIG. 9) and an extension section second edge 248 opposing extension section first edge 246.

Z bar lower section 141 is formed of a bar of rigid material having a lower section first edge 250 (FIG. 9) coupled to extension section second edge 248, and lower section second edge 252 opposing lower section first edge 250.

Lower section 141 lies flat on rigid plate 122 when hook rail 140 is coupled to support plate 120, see FIG. 2. Upper section 143 is held a distance away from rigid plate 124 by extension section 139, also shown in FIG. 2. First horizontal coupling bar 166 sets on extension section 139 when bagging station 160 is hanging from bracket 112, as shown in FIG. 1 and FIG. 2. First horizontal coupling bar 166 is held against rigid plate 122 by upper section 143, as shown in FIG. 2. Upper section 143 and extension section 139 act as a hook to hold first horizontal coupling bar 166. Lower section 141 is used to couple first hook rail 140 to rigid plate 122.

First hook rail 140 also includes first pin 144 and second pin 147. First pin 144 and second pin 147 extend from rear surface 175 of Z bar lower section 141, best seen in FIG. 11 and FIG. 12. First pin 144 includes first pin head 146 and a first pin shaft 145. First pin shaft 145 is coupled to elongate Z bar 142 at a first pin shaft first end 260, see FIG. 11. First pin head 146 is coupled to a first pin shaft second end 262 opposing first pin shaft first end 260.

Second pin 147 includes second pin head 149 and a second pin shaft 148. First and second pin 144 and 147 couple first hook rail 140 to support plate 120, as discussed above. First and second pin heads 146 and 149 have a larger diameter than first and second pin shafts 145 and 148. First pin head 146 is extended through first longitudinal slot 180 at junction 223 (or junction 221, 225, 227, or 229). Second pin head 149 is extended through second longitudinal slot 182 at junction 224 (or junction 222, 226, 228, or 230), as best seen in FIG. 3. First pin 144 is then slid into first L slot 212 (or L slot 210, 214, 216, or 218). Once first pin 144 is slid into first L slot 212, first pin shaft 145 is small enough that first pin shaft 145 can slide along first L slot 212, but first pin head 146 is too large to allow first pin 144 to be removed from first L slot 212. Thus, support plate 120 is captured between first pin head 146 and elongate Z bar 142, and elongate Z bar 142 is coupled to support plate 120. First pin 144 is slid to first L slot leg second end 190, where first pin 144 rests. First pin 144 is thus coupled to support plate 120. Second pin 147 is similarly coupled to support plate 120 by extending second pin 147 through second longitudinal slot 182 and bringing second pin 147 to rest at second L slot leg second end 198. First hook rail 140 hangs from support bar 120 by first and second pin 144 and 147. Each of first and second pin 144 and 147 extend through one of first or second slot opening 124 or 125 to couple first hook rail 140 to support plate 120.

Second hook rail 150 includes third pin 154 and fourth pin 157 (FIG. 2, FIG. 3, and FIG. 5), which couple second hook rail 150 to support plate 120 by extending through one of first or second slot opening 124 or 125, as explained for first hook rail 140. In the embodiment shown, third pin 154 extends through first longitudinal slot 180 at junction 227, and is slid along third L slot 216 to rest, as is shown in FIG. 3. Fourth pin 157 is extended through second longitudinal slot 182 at junction 228, for example, and is slid to rest in fourth L slot 217, as shown in FIG. 3.

The different L slots 210, 211, 212, 213, 214, 215, 216, 216, 217, 218, and 219 are provided to allow for adjustability in the placement of first and second hook rails 140 and 150. This allows for different bagging stations to be accommodated, as well as the capability to hang bagging station 160 at different heights. It is to be understood that first and second slot openings 124 and 125 can include many different shapes, sizes, and configurations of slot openings to accommodate different mounting configurations for hook rail 140 and 150. It is to be understood that first and second hook rails 140 and 150 can be coupled to first or second slot opening 124 or 125 in many different ways. In some embodiments, only one hook rail 140 or 150 is used. In some embodiments, more hook rails than just first hook rail 140 and second hook rail 150 are used to couple bagging station 160, or other bagging stations, to support plate 120. In some embodiments, first and second longitudinal slots 180 and 182 have a different geometry. In some embodiments L slots 210, 211, 212, 213, 214, 215, 216, 216, 217, 218, and 219 have a different geometry. In each embodiment, first and second hook rails 140 and 150 are coupled to support bar 120 using first or second slot opening 124 or 125.

First hook rail 140 includes two spacers 170 and 171, see FIG. 7 and FIG. 9 through FIG. 12. Spacers 170 and 171 are knobs extending from front surface 174 of Z bar upper section 143. Spacers 170 and 171 keep bags that are hanging from bagging station 160 from getting hung up on bracket 112. Second hook rail 150 similarly has two spacers 172 and 173.

First hook rail 140 has a notch 136 and second hook rail 150 has a notch 138 (FIG. 7). Notches 136 and 138 are each on a top edge of first and second hook rail 140 and 150. Notches 136 and 138 can be used for hanging hooks or bag holders, for example.

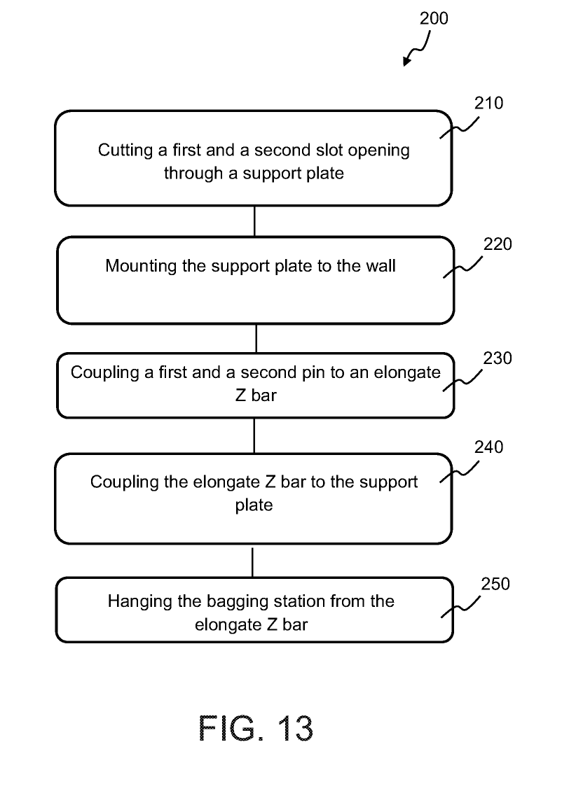

FIG. 13 illustrates a method 200 of mounting a bagging station to a wall. Method 200 includes an act 210 of cutting a first and a second slot opening through a support plate. The support plate is a rigid plate. In some embodiments, the support plate is a rectangular rigid plate. In some embodiments, the support plate includes a first and a second flange for mounting the support plate to a wall.

Method 200 also includes an act 220 of mounting the support plate to the wall. In some embodiments, the support plate has at least one flange for mounting the support plate to the wall.

Method 200 also includes an act 230 of coupling a first and a second pin to an elongate Z bar. In some embodiments, the first and the second pin each include a pin head and a pin shaft.

Method 200 also includes an act 240 of coupling the elongate Z bar to the support plate. In some embodiments, coupling the elongate Z bar to the support plate includes coupling the first pin to the first slot opening. In some embodiments, coupling the elongate Z bar to the support plate includes coupling the second pin to the second slot opening.

Method 200 also includes an act 250 of hanging the bagging station from the elongate Z bar. The bagging station can be hung from the Z bar by hanging a coupling bar of the bagging station from the Z bar. The bagging station can be hung from the Z bar using many different methods.

Method 200 can include many other acts. In some embodiments, the elongate Z bar is a first elongate Z bar, and method 200 also includes coupling a third and a fourth pin to a second elongate Z bar, and coupling the second elongate Z bar to the support plate.

In some embodiments, act 210 of cutting a first and a second slot opening through a support plate includes cutting a first longitudinal slot opening through the support plate extending in a longitudinal direction. In some embodiments, act 210 of cutting a first and a second slot opening through a support plate includes cutting a second longitudinal slot opening through the support plate parallel to the first longitudinal slot opening. In some embodiments, method 200 includes cutting a first L slot through the support plate, where the first L slot extends perpendicularly from the first longitudinal slot. In some embodiments, method 200 includes cutting a second L slot through the support plate, where the second L slot extends perpendicularly from the second longitudinal slot. In some embodiments, coupling the first pin to the first slot opening includes extending the pin through the first L slot. In some embodiments, coupling the second pin to the second slot opening includes extending the pin through the second L slot. In some embodiments, coupling the first pin to the first slot opening includes extending the first pin through the first longitudinal slot and sliding the first pin along the first L slot. In some embodiments, coupling the second pin to the second slot opening includes extending the second pin through the second longitudinal slot and sliding the second pin along the second L slot.

A bagging station system has been shown and described that couples a shopping bag bagging station (bagging station) to a wall. The bagging station system includes a bracket for holding a bagging station. The bracket is coupled to a wall. The bagging station is hung from the bracket. The bracket includes a support plate and at least one hook rail coupled to the support plate. The support plate has a first and a second slot opening in the support plate. The hook rail has at least one pin that extends through one of the first or the second slot openings to couple the hook rail to the support plate. With the support plate coupled to a wall, one or more hook rail coupled to the support plate, and the bagging station coupled to the one or more hook rail, the bagging station is available to dispense shopping bags to employees or customers of a retail store, for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A bracket for holding a shopping bag bagging station, the bracket comprising:
a support plate comprising:
a rectangular rigid plate having a plate top edge, a plate bottom edge, and a plate longitudinal axis;
a first slot opening through the rigid plate;
a second slot opening through the rigid plate;
a first coupling flange coupled to the plate top edge; and
a second coupling flange coupled to the plate bottom edge;
and
a hook rail comprising:
an elongate Z bar formed of a rigid material; and
a first pin and a second pin coupled to and extending from the Z bar;
wherein the first pin extends through the first slot opening and the second pin extends through the second slot opening to couple the hook rail to the support plate.

2. The bracket for holding a shopping bag bagging station of claim 1, wherein the first slot opening comprises:
a first longitudinal slot, wherein the first longitudinal slot is parallel to the plate longitudinal axis;
a first L slot extending from the first longitudinal slot, wherein the first L slot comprises:
a first L slot shaft having a first L slot shaft first end and a first L slot shaft second end opposing the first L slot shaft first end, and wherein the first L slot shaft first end connects with the first longitudinal slot, and wherein the first L slot shaft is perpendicular to the first longitudinal slot; and
a first L slot leg that connects with first L slot shaft second end, wherein the first L slot leg is parallel to the first longitudinal slot.

3. The bracket for holding a shopping bag bagging station of claim 2, wherein the second slot opening comprises:
a second longitudinal slot, wherein the first and the second longitudinal slot have the same length, and wherein the second longitudinal slot is parallel to the first longitudinal slot;
a second L slot extending from the second longitudinal slot, wherein the second L slot comprises:
a second L slot shaft having a second L slot shaft first end and a second L slot shaft second end opposing the second L slot shaft first end, and wherein the second L slot shaft first end connects with the second longitudinal slot, and wherein the second L slot shaft is perpendicular to the second longitudinal slot; and
a second L slot leg that connects with second L slot shaft second end, wherein the second L slot leg is parallel to the second longitudinal slot.

4. The bracket for holding a shopping bag bagging station of claim 3, wherein the first pin extends through the first L slot to couple the hook rail to the support plate, and wherein the second pin extends through the second L slot to couple the hook rail to the support plate.

5. The bracket for holding a shopping bag bagging station of claim 3, wherein the first slot opening comprises five L slots extending from the first longitudinal slot.

6. The bracket for holding a shopping bag bagging station of claim 3, wherein the first L slot shaft and the second L slot shaft are colinear.

7. The bracket for holding a shopping bag bagging station of claim 1, wherein the elongate Z bar comprises:
a Z bar upper section, wherein the Z bar upper section comprises a first bar of rigid material having an upper section first edge and an upper section second edge opposing the upper section first edge;
a Z bar extension section, wherein the Z bar extension section comprises a second bar of rigid material having an extension section first edge coupled to the Z bar second edge and an extension section second edge opposing the extension section first edge, and wherein the Z bar extension section is perpendicular to the Z bar upper section; and
a Z bar lower section, wherein the Z bar lower section comprises a third bar of rigid material having a lower section first edge coupled to the extension section second edge and a lower section second edge opposing the lower section first edge, and wherein the Z bar lower section is perpendicular to the Z bar extension section;
wherein the first pin and the second pin are coupled to the Z bar lower section.

8. The bracket for holding a shopping bag bagging station of claim 1, further comprising a second hook rail coupled to the support plate.

9. The bracket for holding a shopping bag bagging station of claim 1, wherein the first pin comprises:
a first pin shaft coupled to the elongate Z bar at a first pin shaft first end; and
a first pin head coupled to a first pin shaft second end opposing the first pin shaft first end.

10. A bagging station system comprising:
a support plate coupled to a wall;
a first hook rail removably coupled to the support plate;
a second hook rail removably coupled to the support plate; and
a bagging station comprising:
a first horizontal coupling bar that removably hangs from the first hook rail; and
a second horizontal coupling bar that removably hangs from the second hook rail.

11. The bagging station system of claim 10, wherein the support plate comprises:
a rectangular rigid plate;
a first coupling flange extending from a plate top edge of the rectangular rigid plate, wherein the first coupling flange is coupled to the wall;
a second coupling flange extending from a plate bottom edge of the rectangular rigid plate, wherein the second coupling flange is coupled to the wall; and
a first slot opening through the rectangular rigid plate; and
a second slot opening through the rectangular rigid plate, wherein the first and the second slot opening each extend through the rectangular rigid plate from a plate front surface to a plate rear surface.

12. The bagging station system of claim 11, wherein the first hook rail comprises:
an elongate Z bar formed of a rigid material; and
a first pin coupled to the elongate Z bar, wherein the first pin extends through the first slot opening to couple the first hook rail to the support plate; and
a second pin coupled to the elongate Z bar, wherein the second pin extends through the second slot opening to couple the first hook rail to the support plate.

13. The bagging station system of claim 12, wherein the first slot opening comprises:
a first longitudinal slot, wherein the first longitudinal slot is parallel to the plate longitudinal axis;
first L slot extending from the first longitudinal slot, wherein the first L slot comprises:
a first L slot shaft having a first L slot shaft first end and a first L slot shaft second end opposing the first L slot shaft first end, and wherein the first L slot shaft first end connects with the first longitudinal slot, and wherein the first L slot shaft is perpendicular to the first longitudinal slot; and
a first L slot leg that connects with the first L slot shaft second end, wherein the first L slot leg is parallel to the first longitudinal slot.

14. The bagging station system of claim 13, wherein the second slot opening comprises:
a second longitudinal slot, wherein the first and the second longitudinal slot have the same length, and wherein the second longitudinal slot is parallel to the first longitudinal slot;
a second L slot extending from the second longitudinal slot, wherein the second L slot comprises:
a second L slot shaft having a second L slot shaft first end and a second L slot shaft second end opposing the second L slot shaft first end, and wherein the second L slot shaft first end connects with the second longitudinal slot, and wherein the second L slot shaft is perpendicular to the second longitudinal slot; and
a second L slot leg that connects with the second L slot shaft second end, wherein the second L slot leg is parallel to the second longitudinal slot.

15. The bagging station system of claim 14, wherein the first pin extends through the first L slot, and wherein the second pin extends through the second L slot.

16. The bagging station system of claim 15, wherein the first L slot shaft and the second L slot shaft are colinear.

17. A method of mounting a bagging station to a wall, the method comprising:
cutting a first and a second slot opening through a support plate;
mounting the support plate to the wall;
coupling a first and a second pin to an elongate Z bar;
coupling the elongate Z bar to the support plate; and
hanging the bagging station from the elongate Z bar.

18. The method of claim 17, wherein the coupling the elongate Z bar to the support plate comprises:
coupling the first pin to the first slot opening; and
coupling the second pin to the second slot opening.

19. The method of claim 17, wherein the cutting the first and the second slot opening through the support plate comprises:
cutting a first longitudinal slot opening through the support plate extending in a longitudinal direction; and
cutting a second longitudinal slot opening through the support plate parallel to the first longitudinal slot opening.

20. The method of claim 19, wherein the cutting the first and the second slot opening through the support plate further comprises:
cutting a first L slot through the support plate, wherein the first L slot comprises:
a first L slot shaft having a first L slot shaft first end and a first L slot shaft second end opposing the first L slot shaft first end, and wherein the first L slot shaft first end connects with the first longitudinal slot, and wherein the first L slot shaft is perpendicular to the first longitudinal slot; and
a first L slot leg that connects with the first L slot shaft second end, wherein the first L slot leg is parallel to the first longitudinal slot; and
cutting a second L slot through the support plate, wherein the second L slot comprises:
a second L slot shaft having a second L slot shaft first end and a second L slot shaft second end opposing the second L slot shaft first end, and wherein the second L slot shaft first end connects with the second longitudinal slot, and wherein the second L slot shaft is perpendicular to the second longitudinal slot; and
a second L slot leg that connects with the second L slot shaft second end, wherein the second L slot leg is parallel to the second longitudinal slot.
